(19) United States
(12) Patent Application Publication
(10) Pub. No.: US 2006/0241984 A1
(43) Pub. Date: Oct. 26, 2006

(54) Fare and yield driven travel services optimizer for a budget based request system

(76) Inventors: Emmanuelle Godin, Nice (FR); Valerie Viale, Nice (FR)

Correspondence Address: YOUNG & THOMPSON, 745 SOUTH 23RD STREET, 2ND FLOOR, ARLINGTON, VA, 22202, US

(21) Appl. No.: 11/111,944

(22) Filed: Apr. 22, 2005

(51) Int. Cl. G06Q 10/00

(52) U.S. Cl. 705/5

(57) ABSTRACT

A budget based request system includes a travel segments inventory operatively connected to a fare and yield driven travel services optimizer, each travel segment having a yield criteria indicating a degree of difficulty in selling the travel segment. The optimizer responds to a trip search request by determining a travel segments solution set based on the yield criteria of each travel segment, where the solution set is made of travel segments satisfying the travel segments selection criteria.

### BACKGROUND OF THE INVENTION

The invention generally relates to a budget based request system and method for creating travel service packages that optimally matches available travel services with traveler's current travel services needs, taking into account provider yield criteria. The invention accepts, from travel services providers (“providers”), available travel services inventories, and accepts, from travelers (system “users”), a package of current travel services needs as well as a target price for the overall package. The invention divides the target price between the various types of services to be purchased within the overall travel services needs package. The invention thereafter returns to the user a set of travel service proposals for each type of service included in the overall package taking into account the target price, the set of travel service proposals being offered as non-packaged, mixed offers and selected based on yield criteria.

### DESCRIPTION OF THE RELATED ART

A trip comprises an overall package of travel services that together provide the user with the travel services needed to execute his travel plans.

Most users are, at least to some degree, budget driven. Historically, when a user searches for a trip within a given budget, the prior art provides the user with two main families of tools.

The first family of tools could be characterized as price driven. This first family of tools offers searching for holiday trips within a selected price range and with flexibility as to travel dates and destinations. The results of the search are pre-packaged offers including various travel segments, such as transportation and lodging, which fit the price range selected in the request.

In this family of tools, the search engine uses the user's selected price range as the search criteria for searching among fixed sets of travel packages available within a database. These travel packages, however, may or may not have been assembled with respect to yield management system imposed conditions. Thus, yield management conditions are not considered and are not managed.

The second family of tools could by characterized as service requirements driven. This second family of tools offers searching for trips (for leisure or business) by combining services requirements, e.g., air+hotel or air+hotel+car requirements for given dates and destinations but without regard to any price criteria. The search results are offers of combined availabilities of air, hotel and car, but the user is left with the task of determining which packages fit his target trip budget.

With this second family of tools, the user typically has no flexibility on travel dates and destination, yet may still need to be within a budget for the overall travel package. Therefore, so if he wants to find specific travel segments that fit his budget, within the required dates and destinations, he has to repeatedly blindly re-iterate the search multiple times with various inputs but without any clue as to the particular criteria that will ultimately yield a favorable (or at least acceptable) search result. That is, the user is forced to blindly re-iterate the input criteria seeking to find a package comprising the travel segment dates and destinations for which inventories are not well sold and therefore are available at a sufficiently low price to satisfy the budget.

The prior art has sought to address the need for dynamic travel services packaging. For example, the Expedia patent WO03017176 proposes possibly travel segments to the user, but does not create travel packages. The user must select the possible travel segments and himself build his trip.

### SUMMARY OF THE INVENTION

The invention includes a budget-driven optimizer that provides users with non-packaged, mixed travel segment offers selected based on yield criteria, while answering the users' fundamental question of “what is the best trip could I do with this amount of money?”

An object of the present invention is to provide a system for the travel industry whereby distributed and hosted inventories work together to provide a response in a yield driven manner to a user's budget based travel services request. In this way, both user needs and provider needs are addressed.

Another object of the invention is to provide a way to offer hard-to-sell inventories to a user, which user's purchase decision is essentially budget driven within a degree of flexibility as to date and/or destination. In this way, the provider sells the hard-to-sell inventory in an environment that meets the user's needs and satisfies the user's expectations.

Still another object of the invention is to offer best value from both the users' and travel service providers' perspectives in that the users can themselves build their own trip at the best price for the level of service they wish, and the travel service providers effectively market their hard-to-sell inventories.

Yet another object of the invention is to execute the inventive system without additional or special input from the yield management system by relying on data provided for the normal reservation process, and by taking advantage of the presence of hosted inventories directly connected with the reservation system as well as inventories distributed across a network.

### BRIEF DESCRIPTION OF THE DRAWINGS

FIG. 1 is a schematic overview of the inventive system.

FIG. 2 is an activity diagram illustration operation of the inventive system.

FIG. 3 illustrates a trip search request initiated by a user in S100 of FIG. 2.

FIG. 4 illustrates use of three search parameter types.

### DESCRIPTION OF THE PREFERRED EMBODIMENTS

Broadly, the invention is a fare-and-yield-driven travel request system. The core of the system is a fare-and-yield-driven-travel services optimizer (10) and a travel segments inventory (12, 40, 50, 60) operatively connected to the optimizer (both described in more detail below).

The optimizer takes advantage of each travel segment having yield criteria indicating a degree of sales difficulty in selling the travel segment, in order to maximize presentation to the user of travel segments having a high degree of sales difficulty that also meet the user's travel requirements.

The optimizer is configured to respond to a user-generated trip search request by determining a travel segments solution, from a set of travel segments satisfying user-specified travel segments selection criteria contained within the search request, based on the yield criteria of each travel segment in the set. Determining the travel segments solution based on the yield criteria allows the optimizer to maximize selection of travel segments having a high degree of sales difficulty within the travel segments solution to be sent to the user.

Having developed a travel segments solution weighted with hard to sell travel segments, the optimizer generates a electronic travel segments proposal offer file for electronic transmission back to the user, the proposal offer file meeting both the user's needs and the provider's needs.

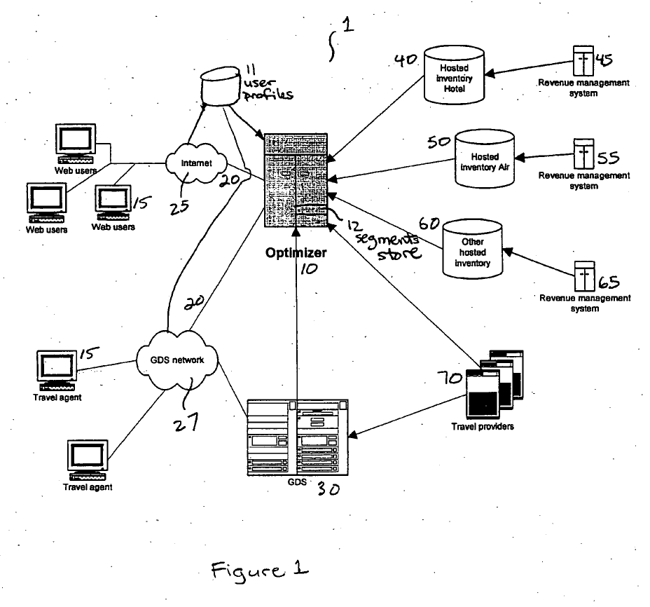

With reference to FIG. 1, the inventive system 1 comprises a budget-driven optimizer 10 that provides users 15 with non-packaged, mixed travel segment offers selected based on yield criteria, while answering the users' fundamental questions of “what is the best trip could I do with this amount of money?” and “what is the least cost for this trip?”.

The yield criteria indicate a degree of sales difficulty in selling each specific travel segment. Each travel segment includes yield criteria indicating a degree of sales difficulty in selling that travel segment. In a non-limiting example, easy-to-sell segments have a yield criteria of “1”, moderately easy-to-sell travel segments have a yield criteria of “2”, and hard-to-sell travel segments have a yield criteria of “3”.

As illustrated, the users 15 may be either travel agents or individual web users.

The users 15 connect to the optimizer 10 via a communications path 20, e.g., such as a computer network 20. Non-limiting examples of the computer network include the internet and a GDS network. The GDS network is in turn connected to a GDS 30. The internet network 20 comprises a web server 25 that links the web users 15 to the internet and to the optimizer 10. The GDS network comprises a travel agency front-office system (FOS) 27.

A user profiles database 11 may be integral to the optimizer 10 or accessible to the optimizer 10 as well as to the web server 25 and the front-office system 27.

The optimizer 10 is further operatively connected to hosted hotel inventory 40, hosted air inventory 50, and other hosted inventory 60. Each inventory may be connected to a revenue management system 45, 55, 65.

Travel providers 70 are connected to both the optimizer 10 and any provided GDS 30.

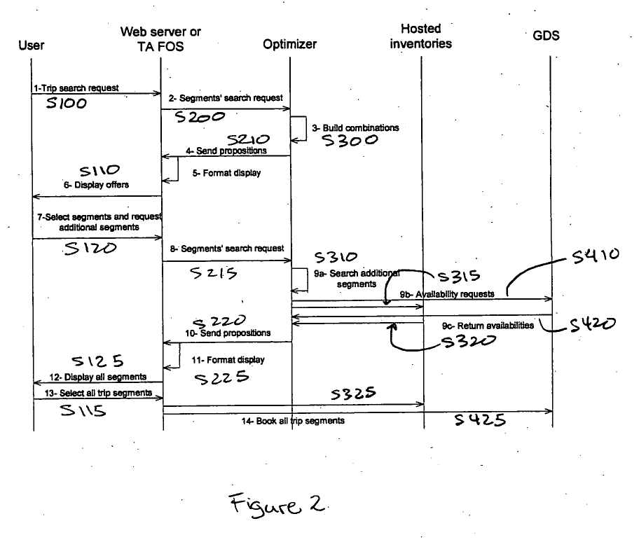

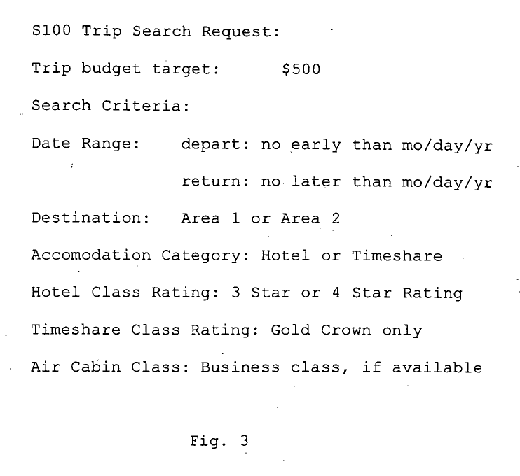

With reference to FIG. 2, the operation of the inventive system begins with a user 15 initiating a trip search request S100 with user-specified travel segments selection criteria. The trip search request may include a trip budget target and search criteria (as specified by the user). The search criteria may include date range and/or destination and/or accommodation category and/or accommodation class category and/or air cabin class code. See FIG. 3 as a non-limiting example. The trip budget target is a monetary amount that the user is willing to spend on the trip.

Note that the user can leave the trip budget target blank, in which case the optimizer assumes the user wants to know what is the least cost for the indicated trip.

The trip search request S100 may include a trip budget target, e.g., $500. This stated trip budget target need not be an absolute limit as the system may recognize that superior combinations are available near the trip budget target, e.g., within 20% of the trip budget target. Alternative currencies, e.g., euros or a local currency may also be specified.

The trip search request S100 may include search criteria stating the date range as comprising a depart date no early than a first specific data and a return date no later than a second specific date. Alternative date ranging techniques also apply. The destination may be specific or include alternative, e.g., travel to Area 1 or Area 2. This is particular helpful in aiding a vacation traveler who is agreeable to vacation in any one of plural locations. Similarly, the accommodation category may include acceptable alternative, e.g., a hotel or a timeshare. For each type of accommodation category specified, e.g., a room class rating may be specified. FIG. 3 illustrates a hotel with a room class rating of 3 Star or 4 Star, and the timeshare room class rating of “gold crown only”. Thus, the user can be specific as to the accommodations that are acceptable. Air cabin class may also be specified.

The trip search request S100 may be initiated any either the web users or the travel agent users. If initiated by a travel agent user, the GDS 30 receives the trip search request 100.

The trip search request S100 is flexible. Non-limiting examples of trip search requests include:

the lowest possible price for a 2-day stay in Cannes during September in a 3-star hotel with a convertible car;

proposals for a 2-day stay in Cannes during September in a 3-star hotel with a convertible car at a maximum of 600 euros;

identify round trip (return) flights to Asia at less than 500 euros for a stay of at least 15 days during winter;

identify a rail trip and hotel package for a 3-days trip from Paris to London the 1st week of October for a maximum budget target of 300 euros; and

identify flights and room in a resort by the seaside in Europe for the second half of August with a maximum budget target of 1000 euros.

From an overall viewpoint, the optimizer 10, upon receipt of the trip search request, searches the hosted inventories, as appropriate, to identify the most difficult to sell travel segment products that satisfy the trip search request's search criteria with the goal of returning to the user travel offers fitting the trip search request's budget target that are also are hard-to-sell travel segments.

The optimizer addresses the needs of the user in that the returned travel offers enable to the user to travel at a low price to a selected destination, within selected dates, and being able to easily package himself his trip without exceeding his budget target. The user makes the travel package in that the user picks, from the returned offers, the flights, accommodations and/or any other proposed travel segments such as car, cruise, and rail.

The optimizer also addresses the needs of the travel services providers in that the returned travel offers are selected based on yield criteria such that the optimizer allows the providers (e.g., airlines, hotels . . . ) to automatically promote and sell their distressed inventories without any manual action needed on their side, such as, for example, sending fax or e-mail to travel agents or pushing promotional data to distribution systems.

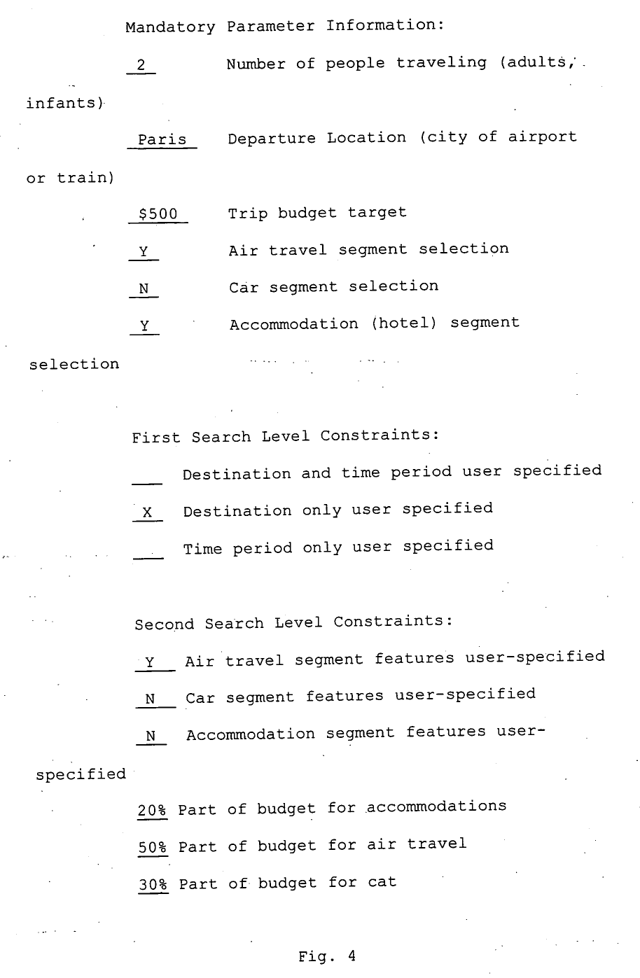

For the optimizer to be successful, from the user's point of view, the returned offers must satisfy the user's travel segments selection criteria. Thus, the search criteria, set by the user in making the trip search request S100, further comprises information relating to three search parameter types. See FIG. 4 schematically illustrating such information as applied to the three parameter types. This information would be solicited from the user in an appropriate manner.

The first parameter type is mandatory parameters (information). The second parameter type is first search level constraints. The third parameter type is second search level constraints.

The mandatory parameter information includes: a. Number of people for the travel (adults and infants)—a number of travelers; b. Departure location (e.g., city of airport or train station); c. Trip budget target; and d. Types of travel segments to be included for the trip budget target (air, hotel but no car for example).

FIG. 4 illustrates the user having provided mandatory parameter information of two people traveling, departing from Paris, a $500 trip budget target with the desired travel segments including air travel and hotel (accommodation) (adults, infants). See that the car segment selection has been excluded in FIG. 4. As noted above, the mandatory trip budget target may be left blank in order to indicate the desire for least costly trip offers, (offers that reflect the least costly travel segment options).

For the first search level constraints, there are three alternatives.

The first alternative is the destination and travel time period both being chosen by the user. Note that travel time period is flexible and may include a season (spring, summer, fall foliage period, etc.), month, week, and specified dates.

See S200 of FIG. 2 indicating either the Web server 25 or the travel agency front-office system 27 on which the request has been entered formats the trip search request to the optimizer. The formatting of the trip search request includes segmenting the information into travel segments and may also include setting some input data to default values based on the user's profile stored in the profiles database 11.

The optimizer takes the user specified destination and travel time period as required search requirements in order to segment the trip search request into plural travel segments.

The optimizer first determines a budget range for each segment type selected in the mandatory parameter information. Selection of budget ranges for each segment type is necessary so that the total budget target for all the segments stays under the maximum budget target set by the user.

Using this required search requirements, the optimizer will look to the hosted inventories for historical data and dynamic average prices per segment and travel time period. The optimizer will further search for hard-to-sell products meeting the required search requirements. The step S300, S310, S315, and S320, as well as S410 and S420 accomplish this overall task.

Thus the system searches for the travel segments requested by the user, each travel segment in a corresponding determined budget range. The search results are used to build offer combinations S300. The offer combinations are formatted and sent as proposals (propositions) S210 via the web server 25 or the travel agency front-office system 27 to be displayed S110 to the user.

The user may himself pick the segments he prefers among the proposals, while remaining under the maximum budget for his trip. The user selected trip segments S115 are sent to the optimizer. The optimizer then co-ordinates user selected trip segments S115 with either the hosted inventories S325 or the GDS S425 in order to book all the trip segments.

In case there is no or only few proposals fitting the required time period, destination and budget target specified by the user, the optimizer may propose hard-to-sell products at optimal price for destinations or dates near the destination and dates specified by the user. In this way, the optimizer broadens the search criteria without further burdening the user.

Of the first search level constraints, the second alternative is only the destination being chosen by the user.

As with the user specifying both the destination and travel period, the optimizer determines a budget range for each type of travel segment in the user's request. Thereafter, the optimizer finds the most hard-to-sell periods for the chosen destination, and searches, in those hard-to-sell periods, the travel segments requested by the user, each travel segment in its budget range. The optimizer insures that the travel segments proposed to the user have an optimal value considering the budget target and the selected destination.

Of the first search level constraints, the third alternative is only the travel time period being chosen by the user.

Again, the optimizer first determines a budget range for each type of segment in the request, and then finds the most hard-to-sell destinations for the chosen period, and searches, at those destinations, the travel segments requested by the user, each in its budget range. In this way, the optimizer insures that the segments proposed to the user have an optimal value considering the budget target and the selected travel time period.

The third parameter type is second search level constraints. These parameters are optional. As illustrated by FIG. 4, these constraints offer the user an opportunity to specify features for each kind of travel segment product.

Further, the user may tune the system out of its default behavior by emphasizing the percentage of the budget that should be dedicated to certain travel segments. In FIG. 4, the user has indicated percentage targets for each of the accommodation travel segment, the air travel segment, and the car travel segment. However, if the can specify percentage targets for fewer than all the travel segments. For example, if the user wants to emphasis dedicating 50% of the budget to accommodations, but does not care how the budget is split between air travel and the car, then only the 50% value need be entered for the accommodations travel segment and the other travel segments may be left blank.

FIG. 4 shows where the user has indicated an interest in specifying search features. Where the user has indicate “Y” for yes, further detailed displays are provided to allow the user to specify the specify features for each kind of travel segment product, e.g., “air economy class on British Airways”, “hotel four stars with pool”, and “sports car with automatic transmission”.

In FIG. 1, the optimizer 10 is shown connected to the hosted inventories 40, 50, 60. These hosted inventories 40, 50, 60 may be local to the optimizer or physically remote from the optimizer, or a combination of both locally stored inventory and remotely stored inventory.

The optimizer stores data sent periodically by the hosted inventories 40, 50, 60 regarding their hard-to-sell travel segments. This data includes the date (departure dates for flights or rail, check-in dates for hotels, pick-up dates for cars . . . ), the length of stay and the associated end-user price.

In order to assure good response times to user requests with flexible criteria, the optimizer may pre-order the travel segments per destination and price range, and pre-associate the segments that could be combined based on the destination and dates. These pre-ordered segments are stored within the optimizer in a segments store 12. In this way, the optimizer can build combinations S300 without reference to the hosted inventories or to the GDS.

For the hosted inventories 40, 50, 60 data sent to the optimizer are automatically deduced from the instructions coming from the Revenue Management Systems 45, 55, 65.

The steps illustrated by FIG. 2 are discussed in more detail below.

In step S100, the user (either a Web site user or in a travel agency user) enters a search trip request S100. Certain information may be pre-inserted (defaulted) into these filed, where the user profiles database 11 already includes such information.

FIGS. 3-4 illustrate criteria information that may be provided by the user as part of the search trip request. S100, or revised if pre-inserted with information from the user database 11. For example, for flights, hotel and car travel segments, the user provides the following criteria:
departure date: fixed or in a date range,
length of stay: fixed or in a range,
destination: fixed or in a region,
air cabin class: chosen by the user, or will be defaulted based on the user profile,
hotel and accommodation category: chosen by the user, or will be defaulted based on the user profile,
car category: chosen by the user, or will be defaulted based on the user profile,
airline: optional,
hotel name or chain: optional,
car company: optional,
trip budget target for the trip: fixed value that will be used as the average of a range (for example, if the user chooses 500 euros, the search range is between 400 and 600 euros). As discussed above, if the trip budget target is left blank, then the lowest price travel segments will be searched.

In step S200 the Web server 25 or the travel agency front-office system 27 formats (segments) the trip search request for the optimizer.

In step S300, the optimizer references the segments store 12 to select, from the segments store 12, the segments matching the segmented trip search request. These selected segments may be combined to satisfy the user's trip budget target. If no trip budget target has been specified, then any combination may be retained in order to determine least costly trip alternatives.

In step S210, if some travel segments satisfy the user's trip search request are found within the segments store 12, then the optimizer sends these segments to the requesting system (server 25 or front-office system 27) to be passed to the user in step S110. If no segments are found that satisfy the search, then a negative answer (a denial) is sent to the user.

As part of step S210, the Web server 25 or travel agency front-office system 27 formats the segments as segment answers to the trip search request. Where there are plural segment answers, the plural segments may be offered to the user so that the user has the opportunity to select any of the satisfying segments. In the case of a negative answer, the user is offered the opportunity to enlarge his search or modify some criteria.

In step S110 the Web server 25 or the travel agency front-office system 27 displays the segment answers to the user.

In step S120 the user consults the displayed results of step S110 and may makes desired selections. If only a part of his trip is covered with the made selections, he can ask for additional segments to complement his made selection. For example, the user can pick the hotel and car segments in the first offered segment results shown from step S110. As part of step S120, the user then asks for additional segment proposals for the flight travel segment, and also for additional services as travel insurance segment.

In step S215 the Web server 25 or the travel agency FOS 27 sends, to the optimizer, the user's S120 response with the made selections and the additional travel segment requests.

In step S310, if additional segments are requested in step S210 and transmitted by step S215, the optimizer again first searches in the segments store 12 to see if some stored segments may fit the new request. If no satisfying segments are found in the segments store 12, the optimizer sends availability requests to the hosted inventories and to the GDS as shown by steps S315 and S410 respectively.

Results are returned in steps S320 and S420.

In step 10, any segment answers from the optimizer are sent to the requesting system, or, if no answer has been found, then a negative answer is sent.

Step S225 indicates the Web server 25 or travel agency FOS 27 formatting the display of the results. In an exemplary embodiment of the invention this is a screen composed of the first selections of the user, and scrolling lists with the new proposals.

Step S125 is similar to step S110, the Web server 25 or travel agency FOS 27 providing displays of the segment answers to the user.

In step S115, the user selects the additional segments of his trip, and sends a booking request to the Web server 25 or travel agency FOS 27.

Steps S325 and S425 show the Web server 25 or travel agency FOS 27 carrying out the reservation of all the segments that constitute the user's trip. The inventories within segment store 12 and the hosted inventories 40, 50, and 60 are updated to reflect the reserved travel segment no longer being available.

1. A budget-based request system, comprising:
a fare-and-yield-driven travel services optimizer (10) in electronic communications with a user (15) over a communications network (20) and accepting, from the user via the communications network, a network-transmitted trip search request (S100),
the trip search request comprising user-input travel segments selection criteria; and
an inventory of travel segments (12, 40, 50, 60) operatively connected to the optimizer (10), each travel segment having a yield criteria indicating a degree of difficulty in selling the travel segment,
the optimizer configured to respond to the trip search request by determining a travel segments solution set based on the yield criteria of each travel segment, the solution set comprised of selected travel segments satisfying the travel segments selection criteria.

2. The system of claim 1, wherein,
the optimizer is configured to maximize the yield criteria indicating hard to sell travel segments.

3. The system of claim 1, wherein, the travel segments solution set is returned to the user, via the network, as non-packaged, mixed travel segment offers,
the travel segment offers being individually selectable by the user.

4. The system of claim 1, wherein, the travel segments selection criteria comprise
a monetary trip budget target amount,
trip search criteria, and
specifications for plural types of travel segments, and
from the trip budget target amount, the optimizer determines a budget range for each of the plural segment types specified by the travel segments selection criteria.

5. The system of claim 4, wherein, the trip search criteria comprise
a date range;
a destination list of plural destinations;
an accommodation list of plural accommodation types;
an accommodation class category list; and
an air cabin class code.

6. The system of claim 4, wherein, the optimizer interprets a blank value of the target amount to indicate a least cost criteria.

7. The system of claim 1, further comprising:
plural separate hosted inventories (40, 50, 60) containing the inventory of travel segments, the plural hosted inventories comprising a hotel segment inventory and an air segment inventory.

8. The system of claim 1, within the optimizer is configured to determine the travel segments solution set based on the yield criteria indicating distressed travel segment inventory.

9. The system of claim 1, wherein the travel segments selection criteria comprise mandatory parameters information, first search level constraints, and second search level constraints,
the mandatory parameter information comprising a number of travelers, departure location information, and a monetary trip budget target amount,
the first search level constraints comprising a selection of only one of three available alternatives, the three alternatives being i) user-selection of destination and travel time period criteria, ii) user selection of only destination criteria, and iii) user selection of only time period criteria, and
the second search level constraints comprising user-selectable travel segment features.

10. The system of claim 9, further comprising:
a user profiles database (11) operatively connected to the optimizer, and
wherein the travel segment selection criteria are at least partially completed by information from the user profiles database.

11. The system of claim 1, wherein the travel segments selection criteria comprise a monetary trip budget target amount, and travel segment allocation criteria for allocating a user-input percentage of the budget target amount to plural different types of travel segments.

12. The system of claim 11, wherein the plural different types of travel segments include hotel travel segments and transportation travel segments, and the travel segment allocation criteria indicate a user-allocation between a hotel travel segment budget amount and a transportation travel segment budget amount.

13. A budget-based request system, comprising:
a fare-and-yield-driven travel services optimizer (10);
a user terminal (15) for user initiation of a trip search request comprising user-input travel segments selection criteria;
a computer network (20) connecting the user terminal to the optimizer for bi-directional communication between the optimizer and the user terminal, the trip search request being sent from the user terminal to the optimizer via the computer network;
a travel segments inventory (12, 40, 50, 60) operatively connected to the optimizer (10), each travel segment inventory comprising plural travel segments having a yield criteria indicating a degree of difficulty in selling each travel segment,
the optimizer configured to respond to the trip search request by determining a travel segments solution set based on the yield criteria of each travel segment, the solution set comprised of selected travel segments satisfying the travel segments selection criteria received by the optimizer from the trip search request.

14. The system of claim 13, wherein, the computer network comprises the internet and a GDS network, the GDS network connected to a GDS (30),
the internet comprising a web server (25) linking first user terminals to the optimizer,
the GDS network comprising a travel agency front-office system (27) linking second user terminals to the optimizer.

15. The system of claim 14, further comprising:
a user profiles database (11) operatively connected to the web server (25) and the front-office system (27);
a hosted hotel inventory (40) and a hosted air inventory (50) operatively connected to the optimizer and providing at least a part of the travel segments inventory (40, 50, 60);
a segments store (12) located within the optimizer and providing another part of the travel segments inventory (12).

16. The system of claim 15, further comprising:
revenue management systems (45, 55) connected to each of the hosted hotel inventory and the hosted air inventory.

17. The system of claim 16, wherein, the travel segments selection criteria comprise a trip budget target and search criteria set,
the search criteria set comprising a travel date range, a destination selection, an accommodation category selection, an accommodation class category selection, and an air cabin class code.

18. The system of claim 17, wherein a blank value for the trip budget target directs the optimizer to configure a least-cost set of travel segments.

19. The system of claim 13, wherein,
the optimizer is configured to maximize the yield criteria indicating hard to sell travel segments, and
the travel segments solution set is returned to the user, via the network, as non-packaged, mixed travel segment offers,
the travel segment offers being individually selectable by the user.

20. A fare-and-yield-driven travel request system, comprising:
a fare-and-yield-driven-travel services optimizer (10); and
a travel segments inventory (12, 40, 50, 60) operatively connected to the optimizer,
each travel segment having a yield criteria indicating a degree of sales difficulty in selling the travel segment,
the optimizer configured to respond to travel segments selection criteria of a received trip search request by determining a travel segments solution, from a set of travel segments satisfying the travel segments selection criteria, maximizing selection of travel segments having a high degree of sales difficulty based on the yield criteria of each travel segment in the set,
the optimizer generating a electronic travel segments offer file comprising the travel segments solution responsive to the received trip search request.
